(19) United States
(12) Patent Application Publication
(10) Pub. No.: US 2022/0187600 A1
(43) Pub. Date: Jun. 16, 2022

(54) METHOD OF REALIZING TOUCH FOR HEAD-UP DISPLAY

(71) Applicant: Panasonic Automotive Systems Company of America, Division of Panasonic Corporation of North America, Peachtree City, GA (US)

(72) Inventor: JIN WOO JUNG, JOHNS CREEK, GA (US)

(21) Appl. No.: 17/547,585

(22) Filed: Dec. 10, 2021

Related U.S. Application Data
(60) Provisional application No. 63/125,251, filed on Dec. 14, 2020.

(51) Int. Cl. G02B 27/01; B60K 35/00

(52) U.S. Cl. CPC G02B 27/0101; B60K 35/00; G02B 2027/0196; B60K 2370/1438; B60K 2370/31; B60K 2370/1529

(57) ABSTRACT

A head up display system for a motor vehicle includes a light field emitter emitting a light field that is reflected off of a windshield of the motor vehicle and that is visible to a human driver of the motor vehicle as a virtual image disposed outside of the windshield. The virtual image includes a plurality of graphical elements. A hand sensor detects a position of a hand of the human driver in space. An electronic processor is communicatively coupled to the light field emitter and to the hand sensor. The electronic processor receives a signal from the hand sensor indicative of the position of a hand of the human driver in space, and determines which one of the graphical elements in the virtual image is aligned with an eye location of the human driver and the detected position of the hand of the human driver in space.

### CROSS-REFERENCED TO RELATED APPLICATIONS

This application claims benefit of U.S. Provisional Application No. 63/125,251, filed on Dec. 14, 2020, the disclosure of which is hereby incorporated by reference in its entirety for all purposes.

### BACKGROUND OF THE INVENTION

### 1. Field of the Invention

The present invention relates to a head up display (HUD) of a motor vehicle.

### 2. Description of the Related Art

A head up display emits light that reflects from the front windshield to be seen by the driver. The light appears to come from a virtual image in front of the driver and in front of the windshield. This type of head up display is currently commercially available.

Conventional head up displays create the virtual image by first using a display or picture generation unit to create an image. Next, the light from the image is reflected from one or more mirrors. Next, the light from the mirrors is directed up to the windshield and is then reflected from the windshield towards the driver. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

A head-up display (HUD) in a vehicle helps the driver keep their eyes on the road, and many car manufactures are offering a HUD system in a car. The HUD system projects graphics in front of the driver. The distance from the driver's eyes to the graphics, which is referred to as the virtual image distance (VID), is 2m or more (for augmented reality HUD, VID is typically at least 7 m or more). Therefore, unlike typical displays in a vehicle, HUD graphics are beyond the reach of the driver's human fingers, which makes the traditional way of user interacting with graphics through touch not possible. That is, for a HUD application, the touch area cannot be in or on the virtual image display area because the virtual image is outside of the windshield and is beyond the arm's length of the driver.

### SUMMARY OF THE INVENTION

The invention may provide a method for defining a touch control area for a HUD application.

The invention comprises, in one form thereof, a head up display system for a motor vehicle including a light field emitter emitting a light field that is reflected off of a windshield of the motor vehicle and that is visible to a human driver of the motor vehicle as a virtual image disposed outside of the windshield. The virtual image includes a plurality of graphical elements. A hand sensor detects a position of a hand of the human driver in space. An electronic processor is communicatively coupled to the light field emitter and to the hand sensor. The electronic processor receives a signal from the hand sensor indicative of the position of a hand of the human driver in space, and determines which one of the graphical elements in the virtual image is aligned with an eye location of the human driver and the detected position of the hand of the human driver in space.

The invention comprises, in another form thereof, a head up display method for a motor vehicle, including emitting a light field that is reflected off of a windshield of the motor vehicle and that is visible to a human driver of the motor vehicle as a virtual image disposed outside of the windshield. The virtual image includes a plurality of graphical elements. A position of a hand of the human driver in space is detected. It is determined which one of the graphical elements in the virtual image is aligned with an eye location of the human driver and the detected position of the hand of the human driver in space.

The invention comprises, in yet another form thereof, a head up display system for a motor vehicle including a light field emitter emitting a light field that is reflected off of a windshield of the motor vehicle and that is visible to a human driver of the motor vehicle as a virtual image disposed outside of the windshield. The virtual image includes a plurality of graphical elements. A hand sensor detects a position of a hand of the human driver in space. An eye sensor detects a position of an eye of the human driver in space. An electronic processor is communicatively coupled to the light field emitter, the hand sensor and the eye sensor. The electronic processor receives a first signal from the hand sensor indicative of the position of a hand of the human driver in space. A second signal is received by the electronic processor from the eye sensor indicative of the position of an eye of the human driver in space. The electronic processor determines which one of the graphical elements in the virtual image is aligned with the detected position of the eye of the human driver and the detected position of the hand of the human driver in space.

An advantage of the invention is that it makes the touch control experience possible for HUD applications.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1a is a schematic overhead view of possible touch areas within a vehicle passenger compartment according to one embodiment of a touch control arrangement of the present invention for a head up display.

FIG. 1b is a schematic side view of the possible touch areas of FIG. 1a.

FIG. 2 is a schematic overhead view of possible touch areas for two separate graphic elements within a vehicle passenger compartment according to one embodiment of a touch control arrangement of the present invention for a head up display.

FIG. 3 is a schematic overhead view of possible touch areas for a graphic element for two different eye positions of the driver.

FIG. 4a is a schematic overhead view of actual touch area selected from the possible touch areas of FIG. 1a.

FIG. 4b is a schematic side view of the actual touch areas of FIG. 4a.

FIG. 5 is a schematic view of a light-based touch system that may be incorporated to sense touching in the actual touch area of FIGS. 4a-b.

FIG. 6 is a schematic overhead view of a common touch area for two different graphic elements for two different eye positions of the driver.

FIG. 7 is a schematic perspective view of touch locations corresponding to a virtual image for a particular eye location according to one embodiment of the present invention.

FIG. 8 is a schematic diagram of a touch decision software block of the present invention.

FIG. 9 is a schematic side view of one embodiment of an automotive head up display arrangement of the present invention.

FIG. 10 is a flow chart of one embodiment of a head up display method of the present invention for a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

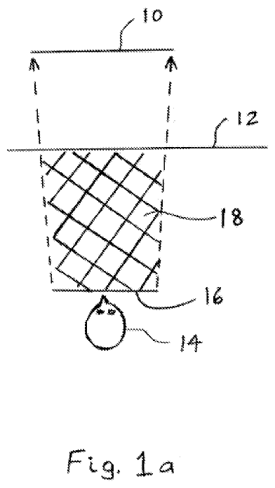

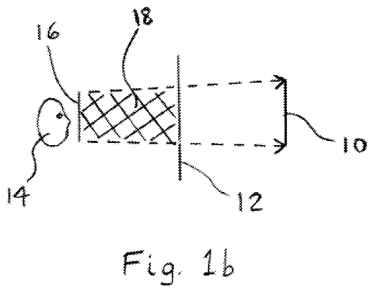

FIG. 1a illustrates possible touch areas within a vehicle passenger compartment according to one embodiment of a touch control arrangement of the present invention for a head up display. A virtual image 10 is visible through a windshield 12 to a human driver 14 when the eyes of driver 14 are in an eyebox 16. Possible touch areas for virtual image 10 are within hashed area 18 between windshield 12 and eyebox 16. FIG. la shows how the virtual image display area, eye box 16, and windshield location impact the possible touch area. Touch area 18 for HUD application can be determined and defined by the location of eye box 16, the location of virtual image 10, and the location of windshield 12, as shown in FIG. 1a. FIG. 1b illustrates the possible touch areas of FIG. 1a (side view). The possible touch areas may be based on the location of eye box 16, virtual image 10, and windshield 12.

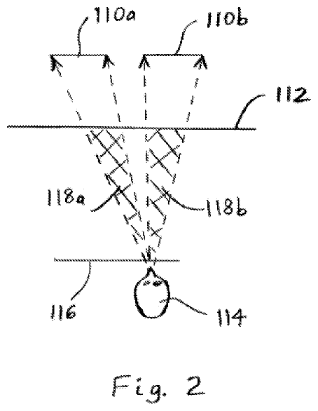

FIG. 2 illustrates possible touch areas for two separate graphic elements within a vehicle passenger compartment according to one embodiment of a touch control arrangement of the present invention for a head up display. FIG. 2 shows possible touch areas 118a-b for two different graphic elements 110a-b when the eye location is fixed. touch areas 118a-b are between eye box 116 and windshield 112. In this illustration, the eye location impacting the driver's view is assumed to be the center of the driver's head, midway between his two eyes.

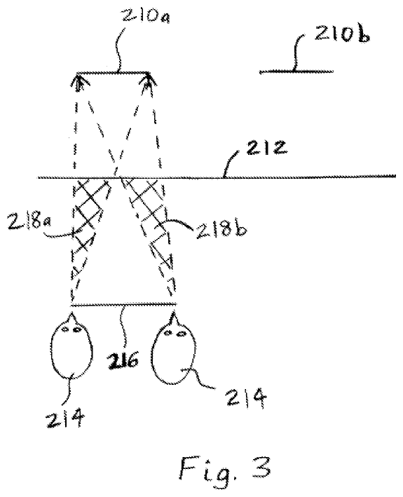

FIG. 2 shows the case where (1) the eye is in a fixed position within eye box 116 and (2) there are two graphic elements 110a-b with which driver 114 can perform touch interactions. As can be seen from FIG. 2, the actual eye position has an impact on the touch area for graphic elements, which can also be seen in FIG. 3. FIG. 3 illustrates how two different eye locations within eye box 216 impact the touch area of the same graphic element 210a. Two different graphic elements 210a-b are in the virtual image display area. As can be seen from FIG. 3, one fixed graphic element 210a can have different touch areas 218a-b depending on and based on the eye location of a driver 214. Possible touch area 218a is for graphic element 210a when the driver's eyes are on the left end of eye box 216, and possible touch area 218b is for graphic element 210a when the driver's eyes are on the right end of eye box 216. Therefore, the decision on the area in which the graphic element can be touched can heavily depend on the driver's eye location. The eye location can be crucial for an accurate and good touch experience for a HUD. Regardless of the eye location, however, the touch areas may be bounded by windshield 212.

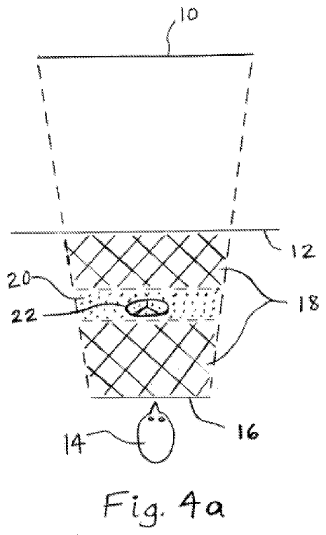

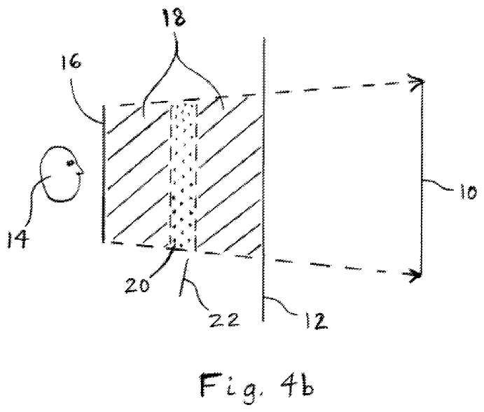

With the possible touch area defined, one (typically a car manufacturer) can decide the actual touch area in 3D space. The touch area doesn't necessarily have to cover the entire possible touch area. For instance, the touch area can be just a small area that the user can easily reach, such as somewhere over the steering wheel. This is illustrated in FIGS. 4a-b where the dotted rectangle is the actual touch area selected, which is located near the top of the steering wheel. It is easy to see that too close to the face area or too far from the face area may not be the best position for the touch area, and the decision is up to the car manufacturer.

FIGS. 4a-b illustrate an actual touch area 20 selected from the possible touch areas 18 of FIG. 1a. Touch area 20 may be a three-dimensional space located near a steering wheel 22. Based on the description so far, it is clear that the touch area for HUD could possibly be in the air, and not on a physical device, as with a touch screen. Having the touch area in the air can be accommodated by using a light-based touch sensor system, for example, which can enable touch in the empty space.

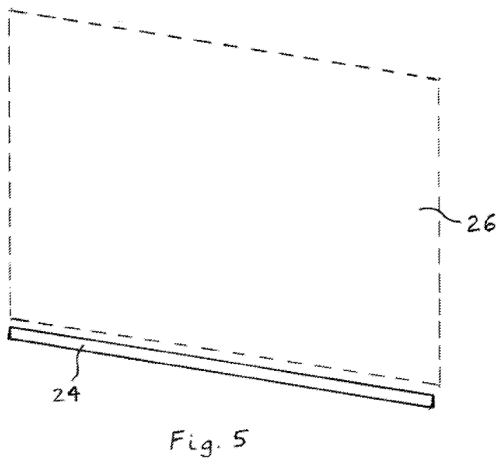

FIG. 5 illustrates a light-based touch sensor system wherein one light sensor strip 24 can enable and detect touch sensing in an air space, such as touch area 20 in FIGS. 4a-b. Sensor strip 24 may generally sense the position of a user's hand in a designated section of air space in front of the user. Different sensor placements and configurations can provide different touch areas (shapes, thicknesses, etc.) in 3D space, such as touch area 26. However, the present invention is not limited to use of a light-based touch system. The invention may incorporate any touch technology that enables and detects touch in the area and air space described in this disclosure.

As disclosed hereinabove, the eye location plays a crucial role in the touch experience for HUD. Thus, eye tracking capability in the car to determine the eye location (preferably the 3D location in space) is needed to provide the best and unlimited touch experience to the user for HUD.

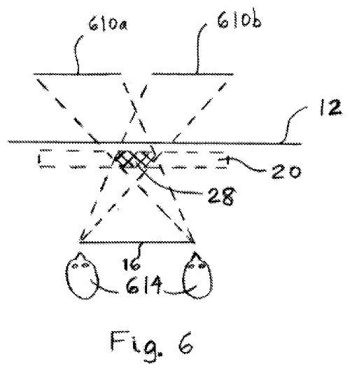

FIG. 6 illustrates a common touch area 28 for two different graphic elements 610a-b for two different eye positions of driver 614. FIG. 6 provides an illustration similar to FIG. 3, wherein FIG. 6 clearly shows what can go wrong when the eye location information is not used for touch consideration. As can be seen from FIG. 6, when the driver 614 touches the common touch area 28 without the eye location information, it is not possible for the touch system to know whether a user touched graphic element 610a or graphic element 610b. However, depending on the size of the graphics elements for touch, the size of the eye box area, the VID, and the size of the virtual display area, driver 614 can still have some touch experience for HUD without the eye location information. However, the user experience in selecting graphics elements can be limited and inaccurate. Also, in the case where the touch experience is not for selecting a particular graphic element but rather for touch gestures like swipe, pinch, zoom, etc., eye location may not be required.

In the cases where the eye location information is needed for the HUD touch experience, due to the unpredictable eye position in time, the decision about which of the graphic elements the user intended to touch needs to be calculated in real-time based on the location of the touchable graphic elements, touched point(s) within the defined touch area, and the eye position. The best and most precise results can be obtained by determining all those values in 3D (x, y, z) space. Since the VID, the virtual image display area, and the touch area are fixed/pre-defined and can be made available to the car system, it is possible to obtain 3D values for the touched point and the graphic elements. A driver monitoring system may determine the eye location in three-dimensional space. Whether determination of 3D values or 2D values of eye locations is called for may depend on the use case. For instance, if the touch experience of HUD is limited to determination of gestures (e.g., swipe, pinch, zoom, etc.) only, then only 2D locations of touch point(s) may be called for.

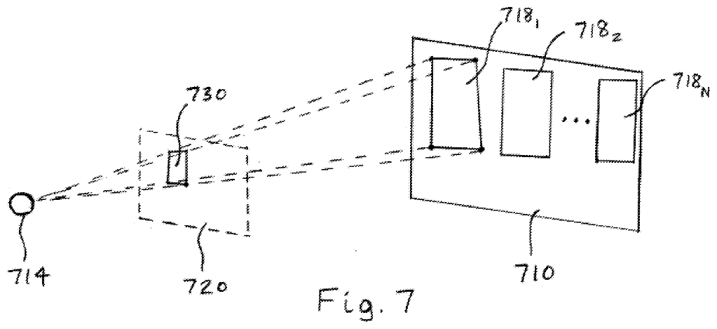

FIG. 7 illustrates touch point locations 730 corresponding to a graphical element 718₁ in a virtual image 710 for a particular eye location 714 according to one embodiment of the present invention. Touch locations 730 are a subset of possible touch locations 720. Virtual image 710 may include N number of graphical elements 718₁, 718₂, . . . , 718_{N}.

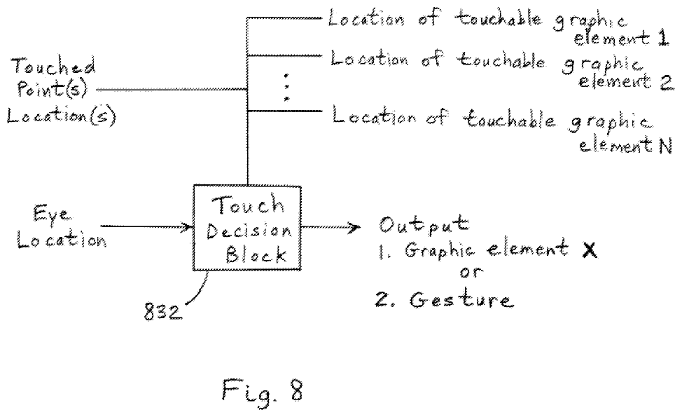

FIG. 8 illustrates a touch decision software block 832 for a touch decision module of the present invention. In this example, the output is either a touched graphic element or a gesture. For the cases when the eye location and 3D information are needed to provide certain touch user experiences, the touch decision block 832 can do needed geometry calculations or similar calculations to decide which touchable graphic element 718₁, 718₂, . . . , 718_{N} is selected. As can be seen from FIG. 7, simple geometry calculations can be applied and used to decide which element(s) and/or point(s) in virtual image 710 is touched when 3D location information of (1) touchable graphic elements 7181, 7182, . . . , 718N, (2) touched point(s) 730 and (3) the eye position 714 are available.

As mentioned above, depending on the HUD touch use cases, not all inputs shown in FIG. 8 may be needed, and the location values may or may not be needed in 3D. For instance, the touch experience that involves gesture detection only (e.g., having only gesture as the output) may require only touch point location(s) as an input to touch decision module block 832, making the module's role very similar to conventional touch software modules.

Disclosed herein is a method of enabling a touch experience for a HUD display and application wherein the graphic area (e.g., the virtual image in the case of HUD) is not reachable by the user. The present invention may provide a method of defining a touchable area for a HUD application based on the location of the eye box, virtual image, and windshield. The present invention may also provide a method of using a touch sensor that can enable touch for the defined touchable area for a HUD application (which is likely to have the touch area in the air) such as (but not limited to) a light-based sensor touch system. The present invention may further provide a method of using information about (1) the touchable graphic elements' locations, (2) the touched point within the defined touch area, and (3) the eye position to make the decision on touch, which enables the most precise touch experience without any touch use case limitation. However, the requirement of a 3D value for the input to make a proper touch decision for HUD can be relaxed based on the touch use cases, which may limit the touch precision, touch use cases, and touch user experiences.

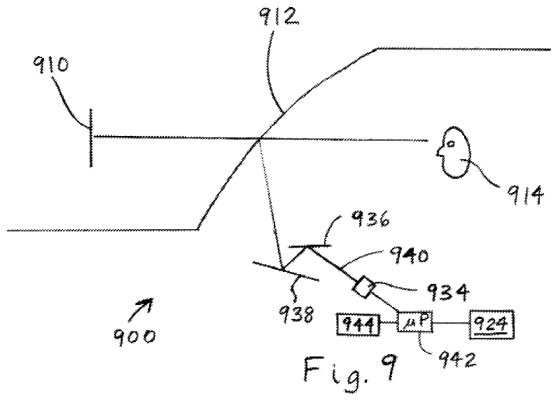

FIG. 9 illustrates one embodiment of an automotive head up display arrangement 900 of the present invention, including a HUD light field emitter (e.g., LCD) 934, an electronic processor 942, a hand sensor (e.g., a light sensor strip) 924, a driver eye location sensor (e.g., a driver monitoring system) 944, a first mirror 936, a second mirror 938 and a windshield 912. During use, light 940 from emitter 934 may be reflected by mirrors 936, 938 and windshield 912 toward a user 914. Light 940 may appear to user 914 as a virtual image 910. Electronic processor 942 may control the content of the emitted light field and may receive signals from sensor 924 indicative of a detected location in space of a hand of user 914. Electronic processor 942 may also receive signals from sensor 944 indicative of a detected location in space of an eye or eyes of user 914.

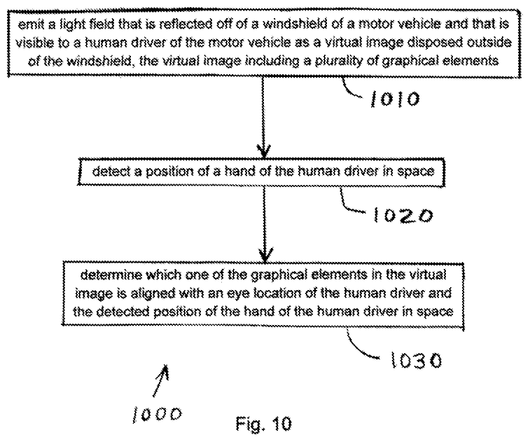

FIG. 10 is a flow chart of one embodiment of a head up display method 1000 of the present invention for a motor vehicle. In a first step 1010, a light field is emitted that is reflected off of a windshield of the motor vehicle and that is visible to a human driver of the motor vehicle as a virtual image disposed outside of the windshield. The virtual image includes a plurality of graphical elements. For example, light field 940 emitted from emitter 934 may be reflected by windshield 912. Light field 940 may appear to human driver 914 as a virtual image 910 disposed outside of windshield 912.

Next, in step 1020, a position of a hand of the human driver in space is detected. For example, hand sensor (e.g., a light sensor strip) 924 may detect the position of the hand of driver 914 in three-dimensional space.

In a final step 1030, it is determined which one of the graphical elements in the virtual image is aligned with an eye location of the human driver and the detected position of the hand of the human driver in space. For example, simple geometry calculations can be applied and used to decide which element(s) and/or point(s) in virtual image 710 is touched when 3D location information of (1) touchable graphic elements 718₁, 718₂, . . . , 718_{N}, (2) touched point(s) 730 and (3) the eye position 714 are available. That is, it can be determined which one of the graphical elements 718₁, 718₂, . . . , 718_{N} in the virtual image 710 is aligned with an eye location of the human driver, as ascertained by driver monitoring system 944, and the position of the hand of the human driver in space, as ascertained by hand sensor 924.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A head up display system for a motor vehicle, the system comprising:
a light field emitter configured to emit a light field that is reflected off of a windshield of the motor vehicle and that is visible to a human driver of the motor vehicle as a virtual image disposed outside of the windshield, the virtual image including a plurality of graphical elements;
a hand sensor configured to detect a position of a hand of the human driver in space; and
an electronic processor communicatively coupled to the light field emitter and to the hand sensor, the electronic processor being configured to:
receive a signal from the hand sensor indicative of the position of a hand of the human driver in space; and
determine which one of the graphical elements in the virtual image is aligned with an eye location of the human driver and the detected position of the hand of the human driver in space.

2. The system of claim 1 wherein the hand sensor is a light-based sensor.

3. The system of claim 1 wherein the hand sensor comprises a light sensor strip.

4. The system of claim 1 wherein the hand sensor is configured to detect a position of a hand of the human driver within a touch area disposed above a steering wheel of the motor vehicle.

5. The system of claim 1 wherein the electronic processor is configured to respond to the determination of one of the graphical elements in the virtual image being aligned with an eye location of the human driver and the detected position of the hand of the human driver in space by performing a function associated with the one graphical element.

6. The system of claim 1 further comprising an eye sensor communicatively coupled to the electronic processor and configured to detect the eye location of the human driver.

7. The system of claim 6 wherein the eye sensor comprises a driver monitoring system.

8. A head up display method for a motor vehicle, the method comprising:
emitting a light field that is reflected off of a windshield of the motor vehicle and that is visible to a human driver of the motor vehicle as a virtual image disposed outside of the windshield, the virtual image including a plurality of graphical elements;
detecting a position of a hand of the human driver in space; and
determining which one of the graphical elements in the virtual image is aligned with an eye location of the human driver and the detected position of the hand of the human driver in space.

9. The method of claim 8 wherein the detecting of the position of the hand is performed by a light-based sensor.

10. The method of claim 8 wherein the detecting of the position of the hand is performed by a light sensor strip.

11. The method of claim 8 wherein the detecting step includes detecting a position of a hand of the human driver in space within a touch area disposed above a steering wheel of the motor vehicle.

12. The method of claim 8 further comprising performing a function associated with the one graphical element in response to the determining of the one of the graphical elements in the virtual image that is aligned with an eye location of the human driver and the detected position of the hand of the human driver in space.

13. The method of claim 8 further comprising using an eye sensor to detect the eye location of the human driver.

14. The method of claim 13 wherein the eye sensor is included in a driver monitoring system.

15. A head up display system for a motor vehicle, the system comprising:
a light field emitter configured to emit a light field that is reflected off of a windshield of the motor vehicle and that is visible to a human driver of the motor vehicle as a virtual image disposed outside of the windshield, the virtual image including a plurality of graphical elements;
a hand sensor configured to detect a position of a hand of the human driver in space;
an eye sensor configured to detect a position of an eye of the human driver in space; and
an electronic processor communicatively coupled to the light field emitter, the hand sensor and the eye sensor, the electronic processor being configured to:
receive a first signal from the hand sensor indicative of the position of a hand of the human driver in space;
receive a second signal from the eye sensor indicative of the position of an eye of the human driver in space; and
determine which one of the graphical elements in the virtual image is aligned with the detected position of the eye of the human driver and the detected position of the hand of the human driver in space.

16. The system of claim 15 wherein the hand sensor is a light-based sensor.

17. The system of claim 15 wherein the hand sensor comprises a light sensor strip.

18. The system of claim 15 wherein the hand sensor is configured to detect a position of a hand of the human driver within a touch area disposed above a steering wheel of the motor vehicle.

19. The system of claim 15 wherein the electronic processor is configured to respond to the determination of one of the graphical elements in the virtual image being aligned with an eye location of the human driver and the detected position of the hand of the human driver in space by performing a function associated with the one graphical element.

20. The system of claim 15 wherein the eye sensor comprises a driver monitoring system.
